(19) United States
(12) Patent Application Publication
(10) Pub. No.: US 2007/0152119 A1
(43) Pub. Date: Jul. 5, 2007

(54) Bracket apparatus

(76) Inventor: Chin-Yang Wang, Tainan Hsien (TW)

Correspondence Address: BACON & THOMAS, PLLC, 625 SLATERS LANE, FOURTH FLOOR, ALEXANDRIA, VA, 22314, US

(21) Appl. No.: 11/324,319

(22) Filed: Jan. 4, 2006

(51) Int. Cl. F16B 47/00

(52) U.S. Cl. 248/205.5

(57) ABSTRACT

The present invention is to provide a bracket apparatus including a first columella and a second columella disposed at two ends of a rod thereof respectively, wherein a first external engaging portion is provided on the outer surface of the first columella for being inserted into one end of a hollow cylinder of a base thereof to engage with a first internal engaging portion formed inside the hollow cylinder, and a second external engaging portion is provided on the outer surface of the second columella for being inserted into a supporting base of a supporting means thereof to engage with a second internal engaging portion formed inside the supporting base, such that the two ends of the rod are not easy to fall off axially from the hollow cylinder and the supporting base of the bracket apparatus.

### FIELD OF THE INVENTION

The present relates to a bracket, and more particularly to a bracket apparatus having two columellas at two ends of a rod separately, so as to effectively prevent the rod from falling off axially from a hollow cylinder or a supporting base of the bracket.

### BACKGROUND OF THE INVENTION

A bracket apparatus for holding accessories, such as an electronic communication device, to a supporting plate on one end of the bracket apparatus, and securely attaching a base on the other end of the bracket apparatus onto a supporting plane, enabling a driver to safely use the electronic communication device while concentrating his/her attention on driving a car.

There are a variety of designs of the bracket apparatuses in the markets. For example, in the prior art, a bracket apparatus 10, as referring to FIG. 1, capable of securely attaching to any supporting plane on a receiving socket for beverage container, glass or tabletop includes a base 11 having a hollow cone symmetrical along the circumference thereof and a hollow cylinder 12 extended upward from the top center of the hollow cone, wherein a pair of corresponding through holes 121 extended upward respectively on the corresponding sides of the hollow cylinder 12 from an extended position of the hollow cone.

The bracket apparatus 10 further includes a suction disc 13 accommodated in a hollow bottom of the base 11 along the direction of the hollow cylinder 12. The suction disc 13 has a diameter approximately greater than or equal to a diameter of the hollow bottom of the base 11 and a bar-shaped pillar 131 extended upward from the top center of the suction disc 13 for being inserted into the hollow cylinder 12 through the hollow bottom of the base 11. Two opposite holes 131 are provided on the bar-shaped pillar 13 at the positions corresponding to the two through holes 121 of the hollow cylinder 12. A spring 133 is sheathed around the periphery of the bar-shaped pillar 131 of the suction disc 13, wherein one end of the spring 133 pushes against the bottom of the hollow cylinder 12 below the two through holes 121, and the other end of the spring 133 pushes against the top of the suction disc 13 around the bar-shaped pillar 131.

In addition, there is a U-shaped operating means 14 disposed outside the hollow cylinder 12 of the base 11. The operating means 14 includes two arms 141 and an operating element 143, wherein the two arms 141 each having a penetrating hole 142 are placed outside the hollow cylinder 12 at the positions corresponding to the two through hole 121 on the hollow cylinder 12 respectively. Thus, after a pin bolt 15 penetrates the penetrating holes 142 on the two arms 141, the through holes 121 on the hollow cylinder 12 and the holes 132 on the bar-shaped pillar 131, the operating means 14, the hollow cylinder 12 along with the base 11 and the suction disc 13 are then pivotally assembled together.

Further, one end of a rod 16 is fixedly inserted into the hollow cylinder 12 at one end distal to the base 11, the rod 16 itself is covered by a flexible tube 161, and the other end of the rod 16 is fixedly inserted into one end of a supporting base 171, the other end of the supporting base 171 is pivotally disposed at a bottom of a supporting plate 172 of a support means 17. In addition to the supporting base 171 and supporting plate 172, the support means 17 further includes a positioning knob 173 disposed between the supporting base 171 and supporting plate 172, which can be adjusted by a user to pivotally turn the supporting plate 172 to an appropriate position for holding and supporting an electronic communication device.

When the operating element 143 of the operating means 14 is pressed downward by a user, the operating arms 141 of the operating means 14 is rotated to push against the base 11 for lifting up the top center of the suction disc 13 and compressing the spring 133 simultaneously, which will press the peripheral of the bottom of the base 11 down to the peripheral of the suction disc 13, enabling the center part of the bottom of the suction disc 13 to be in a vacuum state and securely attach to a flat supporting plane. On the other hand, when the operating element 143 of the operating means 14 is pulled up, the operating arms 141 is rotated to release the force against the base 11, and then the spring 133 is extended to lift the bottom of the base 11 up to a state not pressing on the peripheral of the suction disc 13. Consequently, the bracket apparatus 10 can be easily taken off from the flat supporting plane.

However, since the two ends of the rod 16 are inserted and fixed to the ends of the hollow cylinder 12 and the supporting base 171 merely by using a conventional gluing method to adhere the ends of the above mentioned components together, the glue adhered on the two ends of the rod 16 are easy to loose or peel off while the bracket apparatus 10 being tested in a high temperature environment according to safety regulations requested by foreign buyers before being exported abroad to the buyers, which causes the rod 16 easy to fall off axially from the hollow cylinder 12 and the supporting base 171 and fail to pass the safety test, and in turn causes economic damages to the manufactures. Thus, it is necessary to improve the structure of the bracket apparatus 10 and provide a new design of bracket apparatus with superior stability.

### SUMMARY OF THE INVENTION.

After considerable research and experimentation, a bracket apparatus according to the present invention has been devised so as to overcome the above drawbacks of the prior art.

One object of the present invention is to provide a simple structure to prevent two ends of the rod of a bracket apparatus falling off axially from a hollow cylinder and a supporting base of the bracket apparatus after two ends of the rod being inserted into the hollow cylinder and the supporting base respectively, so as to overcome the above mentioned conventional falling off problem of the rod.

Another object of the present invention is to improve the quality of a bracket apparatus for obtaining more competitive ability among the same kind of products in the market.

In order to achieve above objects, the bracket apparatus according to the present invention includes a first columella and a second columella disposed at two ends of a rod respectively, wherein a first external engaging portion is provided on the outer surface of the first columella for being inserted into one end of the hollow cylinder of a base to engage with a first internal engaging portion formed inside the hollow cylinder, and a second external engaging portion is provided on the outer surface of the second columella for being inserted into the supporting base to engage with a second internal engaging portion formed inside the supporting base. By the foregoing engagement, the two ends of the rod are not easy to fall off axially from the hollow cylinder and the supporting base of the bracket apparatus. The bracket apparatus further includes an operating means disposed outside the hollow cylinder of the base and a suction disc accommodated under the base, such that when an operating element of the operating means is pressed by a user, the bottom of the base is pushed to press down onto the peripheral of the suction disc and let the suction disc to be in vacuum state and securely attach to a flat supporting plane, or when the operating element is pulled up, the bottom of the base 20 is lifted up to a state not pressing on the peripheral of the suction disc and let the bracket apparatus be able to easily taken off from the flat supporting plane.

The above and other objects, features and advantages of the present invention will become apparent from the following detailed description taken with the accompanying drawings.

### BRIEF DESCRIPTION OF THE DRAWINGS

FIG. 1 is a perspective dismantled view of a conventional bracket apparatus;

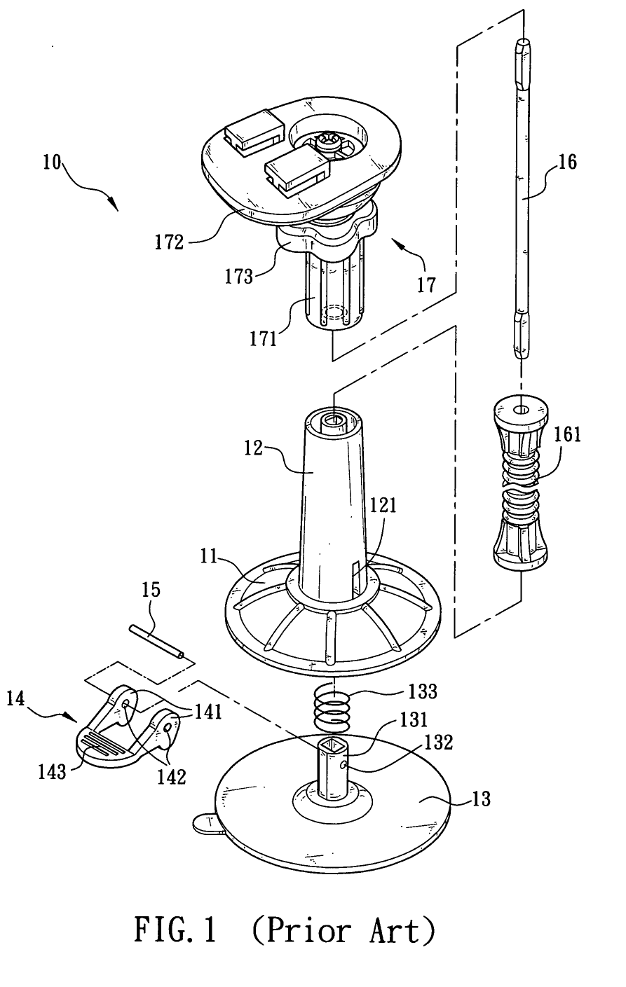

FIG. 2 is a perspective dismantled view of a preferred embodiment of the present invention;

FIG. 3 is a sectional perspective view of the bracket apparatus according to the present invention.

### DETAILED DESCRIPTION OF THE PREFERRED EMBODIMENTS

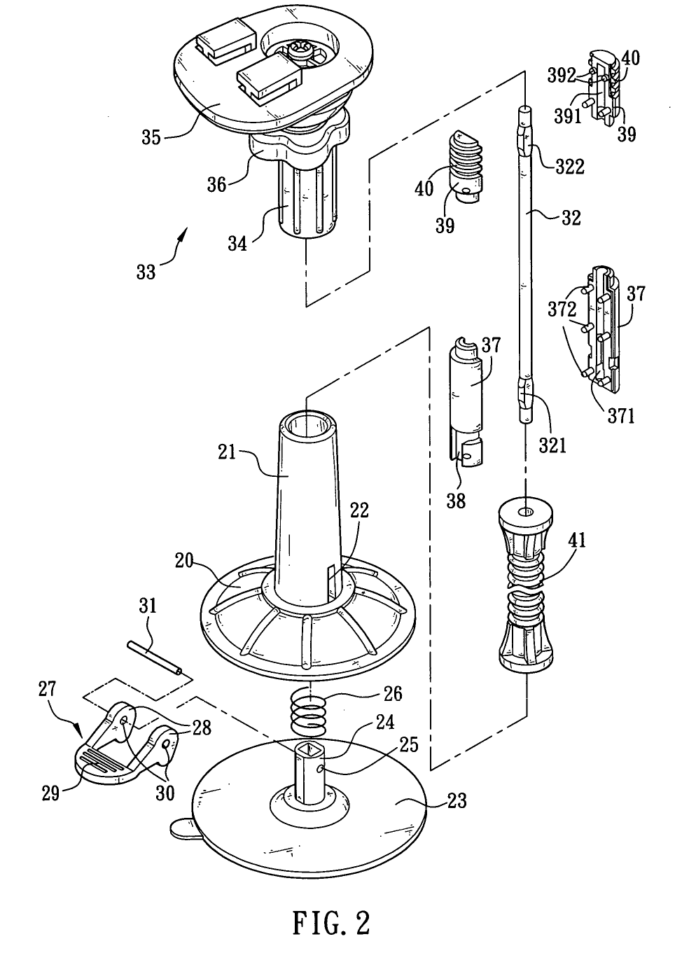

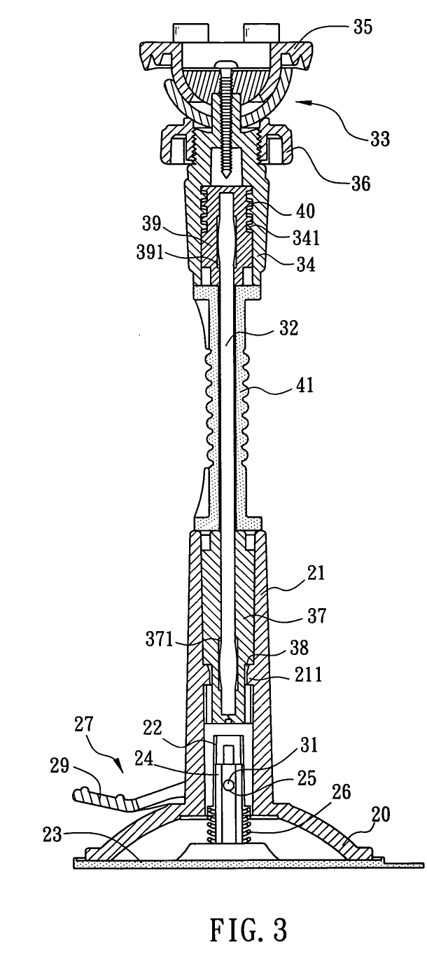

This invention relates to a bracket apparatus, of which a preferred embodiment is shown in FIG. 2 and FIG. 3. The bracket apparatus includes a base 20 having a hollow cone symmetrical along the circumference thereof, a hollow cylinder 21 extended upward from the top center of the hollow cone, and a pair of corresponding through holes 22 extended upward respectively on the corresponding sides of the hollow cylinder 31 from an extended position of the hollow cone.

In the embodiment, a suction disc 23 is accommodated in a hollow bottom of the base 20 along the direction of the hollow cylinder 21. The suction disc 23 has a diameter approximately greater than or equal to a diameter of the hollow bottom of the base 20 and a bar-shaped pillar 24 extended upward from the top center of the suction disc 23 for being inserted into the hollow cylinder 21 through the hollow bottom of the base 20. Two opposite holes 25 are provided on the bar-shaped pillar 24 at the positions corresponding to the two through holes 22 of the hollow cylinder 21.

An elastic element is sheathed around the periphery of the bar-shaped pillar 24 of the suction disc 23. In this embodiment, the elastic element is a spring 26. One end of the spring 26 pushes against the bottom of the hollow cylinder 21 below the two through holes 22, the other end of the spring 26 pushes against the top of the suction disc 23 around the bar-shaped pillar 24.

Further, there is a U-shaped operating means 27 disposed outside the hollow cylinder 21 of the base 20. The operating means 27 includes two arms 28 and an operating element 29, wherein the two arms 28 each having a penetrating hole 30 are placed outside the hollow cylinder 21 at the positions corresponding to the two through hole 22 on the hollow cylinder 21 respectively. Thus, after a pin bolt 31 penetrates the penetrating holes 30 on the two arms 28, the through holes 22 on the hollow cylinder 21 and the holes 25 on the bar-shaped pillar 24, the operating means 27, the hollow cylinder 21 along with the base 20 and the suction disc 23 are then pivotally assembled together.

One end of a rod 32 is inserted into the hollow cylinder 21 at one end thereof distal to the base 20, the rod 32 itself is covered by a flexible tube 41, and the other end of the rod 32 is inserted to one end of a supporting base 34, the other end of the supporting base 34 is pivotally disposed at a bottom of a supporting plate 35 of a support means 33. In addition to the supporting base 34 and supporting plate 35, the support means 33 further includes a positioning knob 36 disposed between the supporting base 34 and supporting plate 35, which can be adjusted by a user to pivotally turn the supporting plate 35 to an appropriate position for holding and supporting an electronic communication device.

According to the above mentioned structure, the skill disclosed in the present invention can be implemented as shown in FIG. 2 and FIG. 3. A first columella 37 is disposed at one end of the rod 32 for being inserted into one end of the hollow cylinder 21, wherein a first external engaging portion 38 is provided on the outer surface of the first columella 37 for being adapted to engage with a first internal engaging portion 211 formed inside the hollow cylinder 21 through the one end thereof as shown in FIG. 3. By the foregoing engagement, the one end of the rod 32 is not easy to fall off axially from the one end of the hollow cylinder 21.

A second columella 39 is disposed at the other end of the rod 32 for being inserted into the supporting base 34 at one end thereof distal to the support means 33, wherein a second external engaging portion 40 is provided on the outer surface of the second columella 39 for being adapted to engage with a second internal engaging portion 341 formed inside the supporting base 34 through the one end thereof as shown in FIG. 3. By the foregoing engagement, the other end of the rod 32 is not easy to fall off axially from the one end of the supporting base 34.

In the embodiment, the rod 32 has a first projection 321 at the one end thereof for being securely fixed to the first columella 37, the first columella 37 includes at least two blocks as shown in FIG. 2, of which the corresponding joining surface of each of the blocks includes a recess 371 for accommodating the first projection 321 at the one end of the rod 32 and a plurality of connecting members 372 for joining the blocks together to the one end of the rod 32 corresponding to the first projection 321 to form the first columella 37.

Further more, the rod 32 has a second projection 322 at the other end thereof for being disposed with the second columella 39, the second columella 39 includes at least two blocks as shown in FIG. 2, of which the corresponding joining surface of each of the blocks includes a recess 391 for accommodating the second projection 322 at the other end of the rod 32 and a plurality of connecting members 392 for joining the blocks together to the other end of the rod 32 corresponding to the second projection 322 to form the second columella 39.

In the embodiment, the first external engaging portions 38 as shown in FIG. 2 are two corresponding inversed L-shaped notches, the first internal engaging portions 211 as shown in FIG. 3 are a pair of tenons, the second external engaging portion 40 is a female thread, the second internal engaging portion 341 is a male thread. While the invention herein disclosed has been described by means of specific embodiments, numerous modifications and variations could be made to the inversed L-shaped notches, the tenons and the threads by those skilled in the art without departing from the scope and spirit of the invention set forth in the claims.

When the operating element 29 of the operating means 27 is pressed downward by a user, the operating arms 28 of the operating means 27 is rotated to push against the base 20 for lifting up the top center of the suction disc 23 and compressing the spring 26 simultaneously, which will press the peripheral of the bottom of the base 20 down to the peripheral of the suction disc 23, enabling the center part of the bottom of the suction disc 23 to be in a vacuum state and securely attach to a flat supporting plane. On the other hand, when the operating element 29 of the operating means 27 is pulled up, the operating arms 28 is rotated to release the force against the base 20, and then the spring 26 is extended to lift the bottom of the base 20 up to a state not pressing on the peripheral of the suction disc 23. Consequently, the bracket apparatus can be easily taken off from the flat supporting plane.

By means of the above components, the first external engaging portion 38 provided on the first columella 37 of the rod 32 is inserted into the one end of the hollow cylinder 21 to engage with the first internal engaging portion 211 formed inside the hollow cylinder 21, the second external engaging portion 40 provided at the second columella 39 of the rod 32 is inserted into the one end of the supporting base 34 to engage with the second internal engaging portion 341 formed inside the supporting base 34, so as to effectively prevent the rod 32 from falling off axially from the hollow cylinder 21 or the supporting base 34. Furthermore, if glue is used to adhere the two columellas disposed on the two ends of the rod 32 to the insides of the hollow cylinder 21 and the supporting base 34 respectively, the two ends of the rod 32 will be more securely fixed within the hollow cylinder 21 and the supporting base 34.

While the invention herein disclosed has been described by means of specific embodiments, numerous modifications and variations could be made thereto by those skilled in the art without departing from the scope and spirit of the invention set forth in the claims.

What is claimed is:

1. A bracket apparatus, comprising:
a base having a hollow cylinder extended upward from the top center of the base, and a pair of corresponding through holes extended upward respectively on the corresponding sides of the hollow cylinder from an extended position of the base, wherein the hollow cylinder has a first internal engaging portion formed inside the hollow cylinder at one end thereof distal to the base;
a suction disc having a diameter approximately greater than or equal to a diameter of the hollow bottom of the base, a bar-shaped pillar extended upward from the top center of the suction disc for being inserted into the hollow cylinder through the hollow bottom of the base, and two opposite holes provided on the bar-shaped pillar at the positions corresponding to the two through holes of the hollow cylinder;
an elastic element being sheathed around the periphery of the bar-shaped pillar of the suction disc with one end thereof pushing against the bottom of the hollow cylinder below the two through holes and the other end thereof pushing against the top of the suction disc around the bar-shaped pillar;
a U-shaped operating means being disposed outside the hollow cylinder, which includes two arms and an operating element, wherein the two arms each having a penetrating hole are placed outside the hollow cylinder at the positions corresponding to the two through holes respectively, and the operating means, the hollow cylinder and the suction disc are pivotally assembled together by inserting a pin bolt into the penetrating holes, the through holes and the holes;
a supporting means including a supporting plate and a supporting base pivotally disposed at a bottom of the supporting plate, wherein the supporting base has a second internal engaging portion formed inside the supporting base at one end thereof distal to the supporting plate;
a rod having a first columella disposed atone end thereof and a second columella disposed at the other end thereof, wherein a first external engaging portion is provided on the outer surface of the first columella for being inserted and adapted to engage with the first internal engaging portion formed inside the hollow cylinder and a second external engaging portion is provided on the outer surface of the second columella for being inserted and adapted to engage with the second internal engaging portion formed inside the supporting base.

2. The structure of claim 1, wherein the first columella includes at least two blocks, of which the corresponding joining surface of each of the blocks of the first columella includes a first recess for accommodating a first projection formed at the one end of the rod and a plurality of first connecting members for joining the blocks of the first columella together to the one end of the rod corresponding to the first projection to form the first columella.

3. The structure of claim 1, wherein the second columella includes at least two blocks, of which the corresponding joining surface of each of the blocks of the second columella includes a second recess for accommodating a second projection formed at the other end of the rod and a plurality of second connecting members for joining the blocks of the second columella together to the other end of the rod corresponding to the second projection to form the second columella.

4. The structure of claim 2, wherein the second columella includes at least two blocks, of which the corresponding joining surface of each of the blocks of the second columella includes a second recess for accommodating a second projection formed at the other end of the rod and a plurality of second connecting members for joining the blocks of the second columella together to the other end of the rod corresponding to the second projection to form the second columella.

5. The structure of claim 3, wherein the first external engaging portions are two inversed L-shape notches.

6. The structure of claim 4, wherein the first external engaging portions are two inversed L-shape notches.

7. The structure of claim 3, wherein the second external engaging portion is a female thread.

8. The structure of claim 4, wherein the second external engaging portion is a female thread.

9. The structure of claim 3, wherein the first internal engaging portions are a pair of tenons.

10. The structure of claim 4, wherein the first internal engaging portions are a pair of tenons.

11. The structure of claim 3, wherein the second interior engaging portion is a male thread.

12. The structure of claim 4, wherein the second interior engaging portion is a male thread.

13. The structure of claim 3, wherein the rod is covered by a flexible tube.

14. The structure of claim 4, wherein the rod is covered by a flexible tube.

15. The structure of claim 3, wherein the support means further includes a positioning knob disposed between the supporting base and the supporting plate capable of being adjusted to pivotally turn the supporting plate to an appropriate position for holding and supporting an electronic communication device.

16. The structure of claim 4, wherein the support means further includes a positioning knob disposed between the supporting base and the supporting plate capable of being adjusted to pivotally turn the supporting plate to an appropriate position for holding and supporting an electronic communication device.

17. The structure of claim 3, wherein the base is a symmetrical hollow cone along the circumference thereof.

18. The structure of claim 4, wherein the base is a symmetrical hollow cone along the circumference thereof.
